(19) United States
(12) Patent Application Publication
(10) Pub. No.: US 2003/0208313 A1
(43) Pub. Date: Nov. 6, 2003

(54) System for computing speeds and estimated arrival times for moving vehicles

(76) Inventors: Charles Hilliary Wells, Redwood City, CA (US); Russell L. Brand, Redwood City, CA (US); Vinodh Kanchi, San Jose, CA (US)

Correspondence Address: Charles H. Wells, 422 Lakeview Way, Redwood City, CA, 94062, US

(21) Appl. No.: 10/135,022

(22) Filed: May 1, 2002

(51) Int. Cl. G01C 21/26

(52) U.S. Cl. 701/204; 340/994

(57) ABSTRACT

A unique method of estimating real time traffic speeds using data from moving vehicles is described. The system uses low cost GPS receivers connected to wireless modems transmitting information to a central server. These data are then used to create speed forecasts for each roadway segment. Typically, roadway segments are 100-200 meters in length and the forecasts have time resolutions down to one minute for each day of the week, week of the month, and month of the year. An approach similar to finite element modeling (FEM) is used to compute the speed and travel time of any vehicle from any point to any destination using the information in the FEM like model. The speed estimates within each element are continually improved as more data is available in that cell. Standard recursive statistics are used for this purpose.

This application is in reference to the Provisional Patent Application No. 60/286,024 and is incorporated herein by reference.

### BACKGROUND of INVENTION

In the US, over 40,000,000 single occupant vehicles (SOV) commute each day, often spending 30 or minutes more in congestion. In the San Francisco Bay area alone, over 2,000,000 SOVs waste over 190,000 hours in congestion each day. This not only wastes highly productive time but also pollutes at much higher rates than while moving.

This invention is designed to reduce congestion by providing users with the means to avoid congestion combined with minimum time enroute. A wireless device (such as a PalmVII) is used to collect position, speed, and direction using a GPS receiver. This information is transmitted wirelessly while enroute to a host computer. The host uses both real-time and historical data to determine the estimated time enroute (ETE) and estimated time of arrival (ETA) for multiple routes to the destination. The user can then make decisions about changing routes in real-time.

This invention specifically covers the methods and algorithms used on the host to perform the calculations.

### SUMMARY

The following paragraphs are intended to comply with 37 CFR 1.71 “Detailed description and specification of the invention”.

This patent describes the host portion of the fastcommute system for collecting data from a moving vehicle, transmitting this to a host computer, computing the estimated time of arrival and estimated time enroute, and transmitting this information back to the vehicle. A companion patent describes the means to send speed and location information to the host computer wireless and is incorporated herein by reference. (patent application, Ser. No. 60/289,016).

It also describes a system that delivers this information to a driver that does not have GPS but any method of receiving wireless communication.

It also describes a phone recipient (not GPS equipped) being given real time updates based on his time of departure and his extrapolated position.

It also describes using cell phone as probes to get location without velocity data and compensating.

The primary objective of the Host is to process real-time traffic flow information from individual “probes” installed in customer vehicles. This data is archived and used for multiple applications. One application includes a low cost vehicle location system for the Paratransit industry.

The system consists of three primary components: (1) a “probe”, also known as an AVL (Automatic Vehicle Locator), (2) host software, and (3) a browser client. The functions of each component are described below:

(1) Probe

The probe consists of a GPS antenna, a PDA (Personal Digital Assistant), and a means to transmit and receive messages to a host computer over wireless Internet. An option to convert received messages to speech will be offered. The probe performs the following functions:

a) sends GPS data to the host computer using a proprietary method that minimizes the required wireless communication bandwidth.

b) receives wireless messages from the host server, such messages could include passenger and routing information.

(2) Host Software

The host software performs the following functions. It will support any reasonable number of clients and probes.

a) archives track data for each vehicle

b) displays present position of vehicles graphically to authorized clients via browser technology

c) provides bi-directional interface to customer scheduling software

d) sends messages to individual probes

(3) Client/Desktop

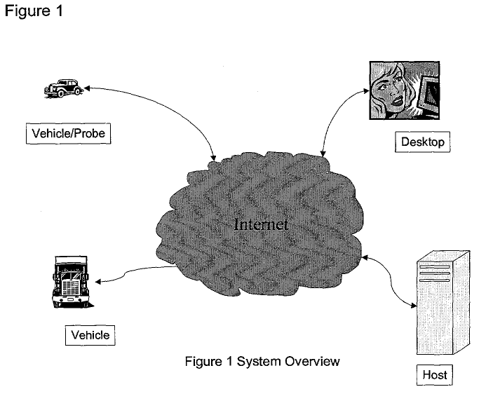

The client is the any Internet browser software having access to the Internet. A block diagram of the system is shown in FIG. 1.

Vehicle/Probe Functions:

(1) read and verify data from a GPS antenna connected to the serial port of the PDA.

(2) Compress GPS data using fastcommute proprietary compression algorithm

(3) Transmit data to host computer wirelessly over the Internet.

(4) If a wireless modem is used: transmit track data in blocks of messages to stay within the calling plan budget.

(5) Receive and display messages from the host computer.

Host functions

(1) receive and archive messages from probes

(2) store this information in a database for later recall

(3) respond to client requests to interactively display position of any or all vehicles belonging to a specific customer

(4) provide interface eta and ete calculations

(5) send messages to probes

Client Functions (Desktop)

Allows users to create maps of their track on an interactive on-demand basis.

### DETAILED DESCRIPTION

Given: N number of vehicles transmitting position, speed and direction in real time to the host computer. Each vehicle transmits its Origin, Destination, and Route number to the host computer upon starting any trip. A route is defined as connected set of x-y points (converted to an element co-ordinate) from the Origin to the Destination. Each route has a unique identifier. Typically, messages are transmitted to the host based on the fastcommute compression algorithm (subject of a second patent) or approximately every minute during the commute. The compression algorithm is designed to transmit messages only when necessary. Compression as used in this context, means sending data to the host only if there has been a change in the speed or direction of the vehicle.

Find: the best estimate of the ETEs for each route for each of the N vehicles. This information is transmitted to each client vehicle every minute.

This problem will be solved using a combination of Finite Element Analysis (FEA) and object oriented programming.

Definitions:

Element: An urban region will be divided into a variable sized mesh of elements. The mesh will be denser in areas of heavy traffic, less dense in the peripheral areas. The w smallest element will be 0.001×0.001 degree of latitude and longitude (approximately 100×100 yards, at 37.000 degrees North latitude and 122 degrees West Longitude).

Location: point on the earth's surface. It has multiple attributes; however, most are not germane to this invention. One of importance, is the capture radius of the point; i.e., a circle about the point, such that if the vehicle is inside the circle, it is considered to have “arrived” at the location.

Trip: a movement from one location to another location, typically identified by the latitude and longitude of the end-point locations. The format of latitude and longitude measures will be decimal degrees wherever practicable ( 37.34221, −122.12345) means + is northern latitudes, − is westerly longitudes. Measurements are in degrees from Greenwich longitude, Equator as latitude. Distances are computed at the host computer using any reasonable model of the earth, (a spherical or oblate spherical model is acceptable for computing typical commute distances). Many trips can be made between the two points; however, there are normally multiple routes by which the trip can be made.

Route: any trip is made along a route. It is defined as an ordered list of elements and directions. There are typically a number of routes for each Origin-Destination pair. Each vehicle will own a number O-D pairs (a trip), each with multiple routes.

Origin: is a location. It is the beginning of a trip. It is located both in the client application and at the host. It consists of a number of fields and is sent from the client to the host as a message. In the future, the user will be able to define a location at the desktop using a Map such as MS Streets and Trips.

Destination: is a location. It is the end of the trip. When one reaches the proximity of this location, the message ARRIVED is transmitted to the client (currently the client recognizes this autonomously). The definition of the arrival circle is input by the user in the client software. This is sent to the host.

Basic Architecture

Each element contains summary information about speeds as a function of time for each direction in the element. The next generation of model will include information from adjacent elements. For each element in the mesh, an instantiation of a super-class object will be created. There could be up to one million objects, if the area was fully populated with the smallest grids (˜100×100 yards) {the actual smallest grid will be 0.001 degrees in latitude and longitude); this will be unlikely in most metropolitan areas. Each object owns child objects such as direction, minute, hour, day, month, etc. The objects will be “serialized” or instantiated under program control so that the resulting model can be saved and restarted without any loss of historical data.

Children of this class are as follows:

(1) A direction class with enum type of degrees in 5 degree increments

(2) A time child-class with enum types in hours and minutes during the day

(3) A day of the week child-class of type Monday, Tuesday, etc

(4) A month child-class of type January, February, March, . . .

(5) A number child-class containing the number of data points thus far in this node.

There will be multiple properties in the “direction” class:

(1) Speed

(2) Standard deviation of speed

(3) Transit time to the boundary of the element, ETE

(4) Number of points

(5) Transit time across the entire element

One can think of direction, minute, hour, day, and month as independent variables and average speed, standard deviation of speed, and ete as dependent variables. Current speed is also independent.

Algorithm is as follows:

For each inbound message:

(1) Identify the element to which the message applies

(2) Identify the direction object, use the message direction to the nearest 5 degrees to determine which object to use.

(3) Identify the minute object

(4) Identify the hour object

(5) Identify the day object

(6) Identify the month object

(7) Invoke the method to compute the properties of this element: average speed, eta to the boundary of the element in the direction of travel, standard deviation. This method uses recursive statistics, see formulae below. Note that the average speed estimate is for this minute, hour, day, and month.

(8) The method call to update the average speed and the ETE is as follows:

X=speed.element.direction.minute.hour.day.month

Y=ete.element.direction.minute.hour.day.month (current position)

Z=transit.element.direction.minute.hour.day.month (average time transiting the element)

(9) The method to compute the now speed in this cell is as follows: the now speed estimate is the time weighted average of this raw measurement. The time weighting will be controlled by a weight factor, typically 10 minutes. For example if the average speed in the element is 60 mph at 8:10 am and 50 mph at 8:20 am, but the raw measurement is 70 mph; then, the now value of speed at 8:10 is 70 mph, at 8:11 am, the now value of speed is 69, then successively lower until at 8:20 am, the now speed equals the historical average at 8:20 am, i.e., 50 mph. This is tricky calculation since the bottom value of the speed changes with time.

The X variable is the property of the element in this direction for this minute, hour, and day and for this month (holidays to be added later).

The Y variable is the ETE property for this element from the current position of the vehicle to the boundary of the element in the current direction of the vehicle. The base unit of time will be SECONDS. The ETE will be computed by using the now value of speed for the element, the current position of the vehicle, and the computed distance to the boundary of the element in a straight line from the current position to the boundary and in the current quantized direction. We also compute the ETE from the entry of the element to the exit in the direction of entry: this is the total transit time in this direction. This will be the number of seconds in the element.

Recursion formulae:

For mean use:

$$\begin{matrix}{\overline{x}}_{n} = ( \frac{n - 1}{n} ) \times {\overline{x}}_{n - 1} + ( \frac{1}{n - 1} ) \times {z}_{n} & \text{Eq. 1} \\ {S}_{n} = {\sum }_{j = 1}^{n} {z}_{j}^{2} & \text{Eq. 2} \\ {S}_{n} = ( \frac{n - 1}{n} ) \times {S}_{n - 1} + ( \frac{1}{n} ) \times {z}_{n}^{2} & \text{Eq. 3}\end{matrix}$$

Computation of the ETE for the remaining portions of the route.

Above we described how to compute the ETE for the element based on the history, including the current data point and how that point is weighted in future time. From the Route tables, the remaining elements and directions along the route are retrieved. The route table includes not only the element, but also the direction. For each element a new value of “minute, hour.day.month” is computed based on the “now” time and the ete to arrive at the next element. Assuming that there are no current “real-time” speed measurements in the elements along the route, then the existing historical ETE data for that element at the predicted time is retrieved. The sum of all the ETEs is the ETE for the remainder of the trip.

The above procedure applies whether or not there are elements ahead with new raw speed data. The intent is to have other vehicles ahead reporting in simultaneously; hence providing real-time information about future speeds to the vehicle behind.

If the now speed value is below a threshold, Y (˜5 mph), then the threshold value will be used in the new ete estimate. This will handle the case where speed is zero.

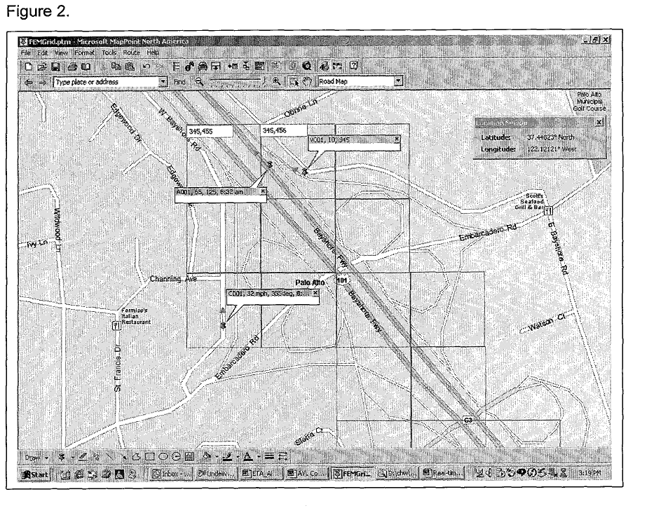

An example of a typical element is shown in FIG. 2. This is an element layout near the city of Palo Alto Calif.

The MapPoint file containing this grid is included on the CD; click here. Reader must have Microsoft MapPoint loaded on the computer to see this file.I.

Display of Progress without using a Purchased Map

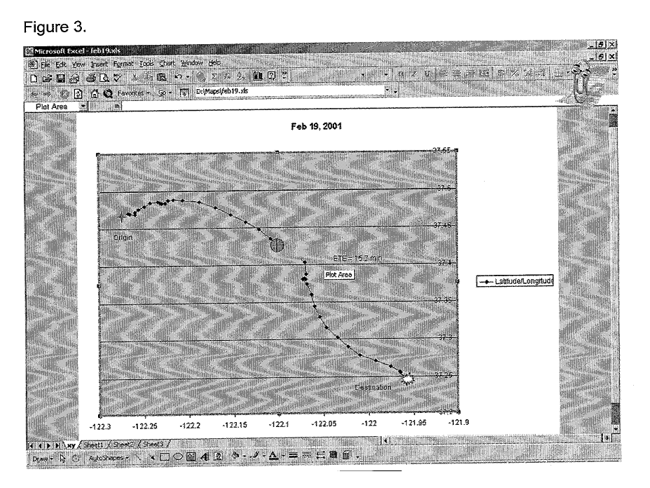

An example of a position plot is shown using an Excel spreadsheet as shown in FIG. 3. It shows the position of the vehicle in real-time on an XY diagram. The X-axis is longitude and the Y-axis is latitude. Thus anyone downloading data from the host web site would be able to plot the latitude and longitude versus speed. This would help the individual commuter understand where the slow points in the slow points in the commute are located.

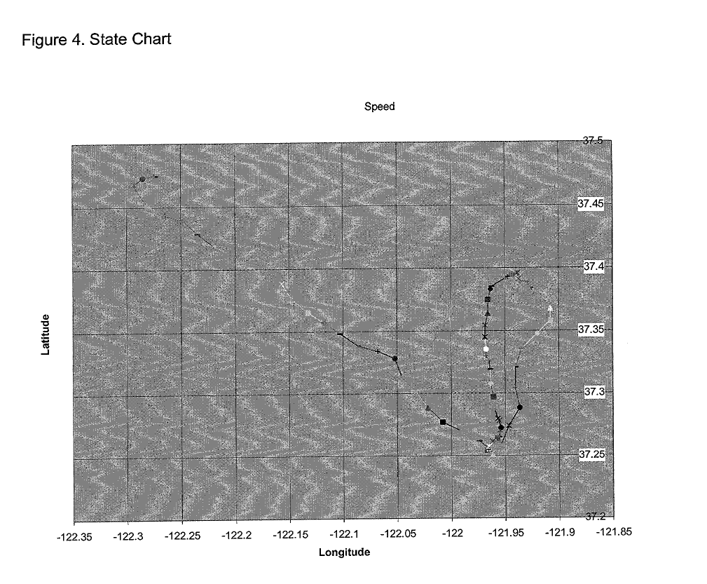

A “State chart” can also be displayed as shown in FIG. 4. This is a plot of speed versus distance, speed is the ordinate and distance is the abscissa. Observe that speed is the first derivative of distance. The distance is the route distance.

An example of a state chart computed from a commute on Apr. 16, 2001 using data from the “probe” described in a companion patent, application Ser. No. 60/289,016 which is incorporated herein by reference.

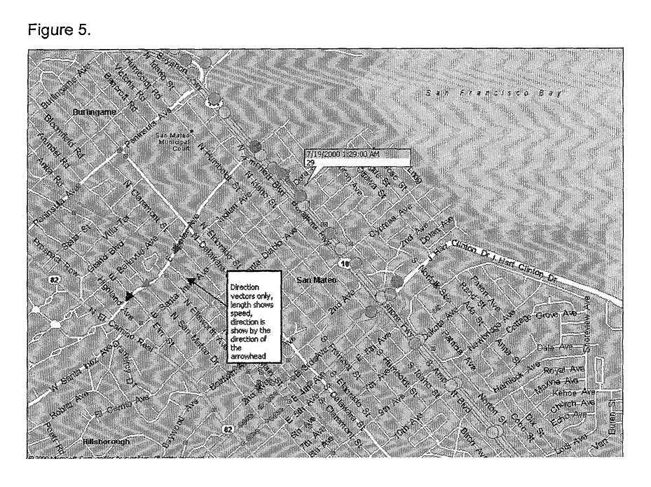

Method of displaying speed and direction as a function of latitude and longitude is shown below in FIG. 5. This chart shows position on a Map as well as speed. Thus three dimensional information is displayed as well at time.

Additional uses for the Information Derived on the Host Side:

Historical Tracking Data

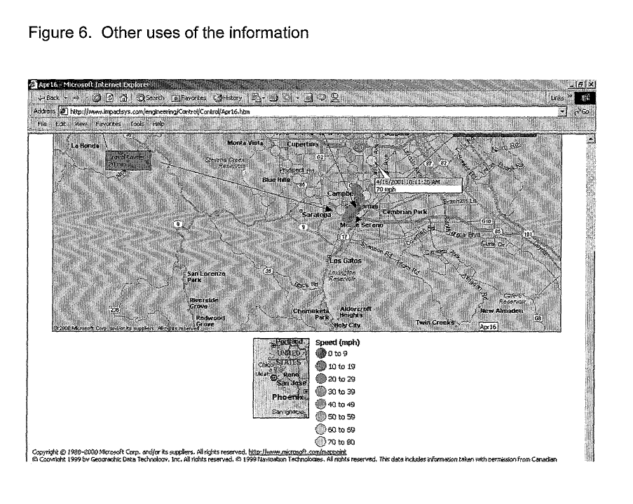

The information contained in the host includes a compete model of the street speeds in the area covered by vehicles having GPS receivers as well as an archival and retrieval mechanism for each trip taken by the vehicle. The raw data is stored in a database and can be recalled by the user over the Internet using any Browser. Examples of the types of images generated are shown in FIG. 6.

This shows both position and speed over-laid on a street map. The notes can be added programmatically. Note that the data displayed is showing four independent variables: time, latitude, longitude, and speed.

Congestion Maps:

This system provides a convenient method of creating and publishing “congestion” maps.

Traffic Congestion Map Algorithm

This document describes an algorithm that could be used to create a “congestion map”. A traffic congestion map would be available to any browser on the net showing real-time traffic congestion. It provides users with nearly instantaneous recognition of problem areas along their proposed route. Having this information in real time allows them to make decisions about driving directions.

The “fastcommute” SQL database contains latitude, longitude, speed as well as the date and time the sample was collected from the AVL probe. The newest information should be no older 20 seconds by the time it arrives at the fastcommute server; however, its time stamp is accurate to the nearest one second.

All records in the database that are less than 5 minutes old are collected and used to color a map: one such as “MapPoint” from Microsoft. The database contains time compressed sequential records from each vehicle.

The average speed for the last five minutes is computed for each vehicle. The average is the geometric average not the time average. The distance traveled divided by the total time is the average speed.

For each vehicle, a rectangle is drawn on the Map beginning at its most recent position to the next youngest position. The speed and direction between these two points is constant due to the compression algorithm in the AVL probe. The dimensions of the rectangle are about 30 feet wide, by the distance between the two adjacent points. The color of the rectangle is determined by the speed limits on the road and the speed at the “beginning” of the rectangle. A typical coloring scheme might be as follows:

(1) speed>speed limit “green”

(2) 50% speed limit<speed<speed limit “yellow”

(3) speed<50% speed limit “red”

The next rectangle would be plotted using the next set of points, but one time interval older. The algorithm keeps drawing rectangles until the time is greater than X minutes in the past from the current time. This is repeated for all vehicles in the database.

The geometry of the first two rectangles for one of the vehicles is as follows:

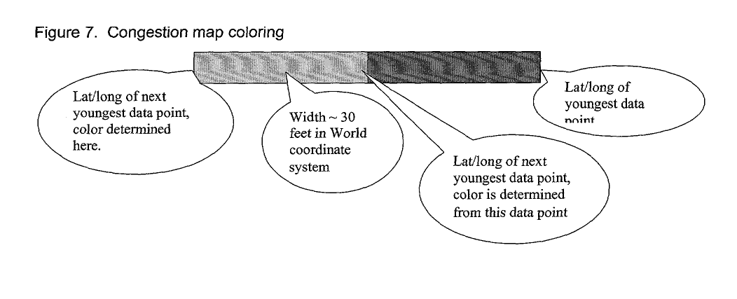

A new map is created every 60 seconds and published to the web page. The congestion map coloring algorithm is shown in FIG. 7.

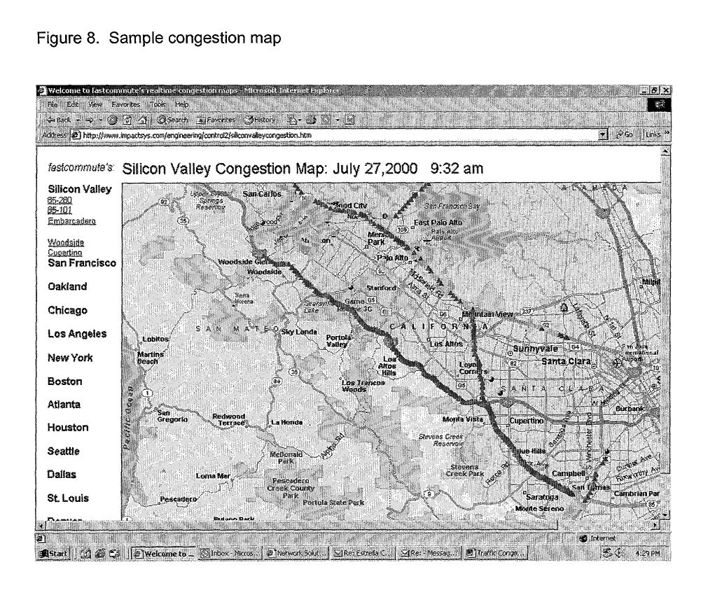

A prototype page is shown in FIG. 8:

The algorithm described above was not used to generate this image, but rather the standard “push pins” in MapPoint were used. The pushpins are fixed size, whereas the proposed algorithm would use variable length rectangles to paint the map.

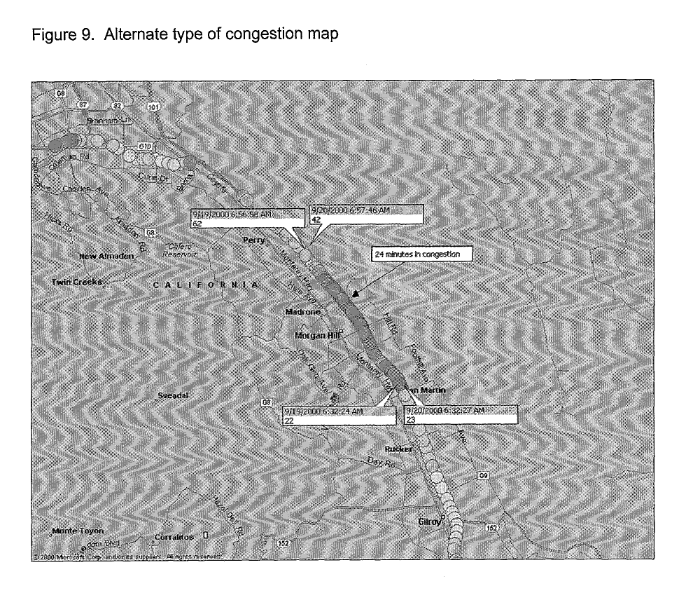

Another type of congestion map is shown in FIG. 9. This is created as a “3D” chart as described earlier in this application.

Delivery of Information to Drivers with Cell Phones:

The same information content could be delivered to users of cell phones. This information could be delivered based on the cell tower the phone is currently using to connect to the network. Based on this information, the host computer could deliver SMS messages or synthesized voice messages over the cell phone network.

Delivery of Information to Drivers with Location Devices:

The same information content could be delivered to users of cell phones with location devices This information could be delivered based phone location (E911) type of location devices. Based on this information, the host computer could deliver SMS messages or synthesized voice messages over the cell phone network.

Delivery of Information to Drivers without a GPS

One of the major benefits of this invention is that the data from a relatively small number of probes can be processed then delivered to a large group of subscribers. For example a user may subscribe to this service, but not have a GPS only a wireless device. The information on the roadway speeds can be delivered wirelessly to the PDA device based on an assumed position of the commuter. For example, a commuter would normally leave for work around 0730 hours and take one of several fixed routes to work. The user would register with the service and describe or select normal routes. The host computer would compute the ete and eta for each route and send this information wirelessly to the user.

Delivery of Information to Drivers with Cell Phones:

The same information content could be delivered to users of cell phones. This information could be delivered based on the cell tower the phone is currently using to connect to the network. Based on this information, the host computer could deliver SMS messages or synthesized voice messages over the cell phone network.

Delivery of Information to Drivers with Location Devices:

The same information content could be delivered to users of cell phones with location devices This information could be delivered based phone location (E911) type of location devices. Based on this information, the host computer could deliver SMS messages or synthesized voice messages over the cell phone network.

We claim the following:

1. In a fast commute system for automotive vehicles driving on a roadway, an automatic vehicle locator for position, speed and direction data installed in a plurality of vehicles; central processing means for receiving at least some of said locator data, over time from multiple vehicles and using both historical and real time data to compute estimated time enroute (ETE) of a particular vehicle.

2. A fast commute system as in claim 1 where said particular vehicle provides origin, destination, and route information to said central processing means.

3. A fast commute system as in claim 1 where said central processing means suggests and transmit to said particular vehicle alternate routes for a better ETE.

4. A method of recalling historical data and plotting it on a map showing position and speed (four dimensional data) time, speed, latitude, longitude and displaying this over the Internet using a browser.

5. A method of generating “congestion” maps and publishing these over the Internet.

6. A method of delivering information in the database to those without GPS data but having a PDA.

7. A method of delivering information to drivers with cell phones.

8. A method of delivering information to drivers knowing only location information (E911) phones.

9. A method of displaying speed as a function of latitude and longitude.

10. A method of displaying distance versus speed as a characterization of a commute.

11. A method of displaying speed and direction as a function of latitude and longitude.
